(19) United States
(12) Patent Application Publication
(10) Pub. No.: US 2021/0245161 A1
(43) Pub. Date: Aug. 12, 2021

(54) PCR BASE AND PCR DEVICE

(71) Applicant: Monad (Suzhou) Biotechnology Co., Ltd., Suzhou, Jiangsu (CN)

(72) Inventor: Shanghai NIE, Suzhou, Jiangsu (CN)

(21) Appl. No.: 17/043,525

(22) PCT Filed: Aug. 16, 2019
(86) PCT No.: PCT/CN2019/100901

§ 371 Date: Sep. 29, 2020

(30) Foreign Application Priority Data
Jan. 29, 2019 (CN) 201910087842.8

(51) Int. Cl. B01L 7/00

(52) U.S. Cl. CPC B01L 7/52; B01L 2300/046; B01L 2300/185; B01L 2300/1805; B01L 2300/0829

(57) ABSTRACT

A PCR base and a PCR instrument. The PCR base includes a metal block provided with a plurality of well grooves for holding tubes on a PCR well plate; under an ambient condition of a room temperature being 22±2□, a well spacing of the PCR well plate is d0, well spacing of the PCR base is d1, well spacing d1 of the PCR base is greater than the well spacing d0 of the PCR well plate, and d1=d0+Δd. Δd refers to a thermal expansion compensation value. During a polymerase chain reaction (PCR), the well spacing d0 of the heated PCR well plate extends to be close to the well spacing d1 of the PCR base, the well grooves of the PCR base no longer limit expansion and extension of the PCR well plate, a surface of the PCR well plate is in a planar state, and an upper hot cover is well covered on the surface of the PCR well plate.

### TECHNICAL FIELD

The present invention relates to the technical field of biological detection, and particularly to a PCR base and a PCR instrument.

### BACKGROUND

A polymerase chain reaction (PCR) is a molecular biological technology used for magnifying and amplifying a specific DNA fragment. In the PCR, DNA denatures into a single chain at a high temperature of 95° C. in vitro, a primer is combined with the single chain according to a complementary base pairing rule at a low temperature (usually around 60° C.), and then, DNA polymerase synthesizes a complementary chain along a direction of phosphoric acid to pentose by adjusting the temperature to an optimal temperature (around 72° C.) for the DNA polymerase reaction. An implementation of the PCR generally requires a PCR instrument to control the temperature of each reaction stage and heating time.

To prevent test solution from volatilizing upward in the high-temperature PCR, a hot cover unit is generally covered above a well plate of the test solution by the PCR instrument to reduce volatilization of the test solution with the high temperature above the well plate. The PCR well plate which is usually made of plastic will expand greatly after being heated, but a PCR base that is generally made of metal and used for placing the PCR well plate has an extremely small thermal expansion rate. As shown in FIG. 1, since well grooves on the PCR base 91 limit tube walls of the PCR well plate 92, the PCR well plate 92 cannot normally extend along a plane after thermal expansion and further enters an arching state in the middle. Therefore, an upper hot cover 93 cannot completely contact the upper surface of the PCR well plate 92, affecting a heating effect, causing heating nonuniformity of each well position of the PCR well plate, leading to evaporation of PCR reaction solution, and affecting accuracy of a PCR detection result.

### SUMMARY

To overcome the above shortcomings of the prior art, an object of the present invention is to provide a PCR base and a PCR instrument.

To achieve the above object and solve the technical problem of the present invention, a technical solution adopted by the present invention is described as follows: a PCR base includes a metal block, wherein the metal block is provided with a plurality of well grooves for holding tubes on a PCR well plate; under an ambient condition of a room temperature being 22±2° C., a well spacing of the PCR well plate is d₀, a well spacing of the PCR base is d₁, the well spacing d₁ of the PCR base is greater than the well spacing d₀ of the PCR well plate, and d₁=d₀+Δd, where Δd refers to a thermal expansion compensation value.

Compared with the prior art, in the present invention, the well spacing d₀ of the heated PCR well plate extends to be close to the well spacing d₁ of the PCR base during the PCR. The well grooves of the PCR base no longer limit expansion and extension of the PCR well plate, a surface of the PCR well plate is in a planar state, and an upper hot cover can be well covered on the surface of the PCR well plate. Therefore, evaporation and cross-contamination of test solution in the PCR well plate are prevented, heating uniformity of each well position of the PCR well plate is improved, and accuracy of PCR detection is increased.

Further, the thermal expansion compensation value is Δd=ΔT*s*d₀, where ΔT refers to a temperature difference value being 20-80 K, and s refers to a thermal expansion coefficient of a material of the PCR well plate and is (30−250)*10⁻⁶ mm/K.

Further, the well spacing d₁ of the PCR base is (1+0.06%)d₀≤d₁≤(1+2%)d₀.

By adopting the above preferable solution, the thermal expansion compensation value with wide applicability is obtained according to a common material expansion rate of the PCR well plate and a large number of pilot experiments, thereby effectively eliminating arching deformation of the heated PCR well plate and considering universality of the PCR base at the same time.

A PCR instrument includes:

the above PCR base, on which a PCR well plate is placed;

an upper heating unit, including a hot cover and a heating element, wherein the heating element is used to heat the hot cover, and the hot cover is covered on an upper surface of the PCR well plate during a PCR; and

a lower temperature controlling unit, disposed below the PCR base and used to perform temperature control for the PCR base.

By adopting the above preferable solution, the heated PCR well plate no longer deforms, and the hot cover can be matched with the surface of the PCR well plate better.

Further, a first driving mechanism for driving the upper heating unit to ascend and descend is included.

Further, a supporting block is disposed on the PCR base corresponding to an edge below a lip side of the PCR well plate, a vertical guide post is disposed at the bottom of the supporting block, a guide hole matched with the vertical guide post is disposed on the PCR base, and a second driving mechanism for driving the supporting block to move up and down is included.

Further, the second driving mechanism includes a beveled block, a horizontally disposed lead screw pair and a drive motor, the supporting block is mounted on a bevel of the beveled block, the beveled block is connected with a nut of the lead screw pair, and the drive motor drives a lead screw of the lead screw pair to rotate.

By adopting the above preferable solution, the second driving mechanism pushes against the supporting block before the PCR well plate is placed, the PCR well plate is supported on the supporting block by means of its lip side at the edge, and the PCR well plate is not completely placed in the well grooves of the PCR base, thereby effectively preventing concave deformation of the PCR well plate mounted on the PCR base before thermal expansion. After the PCR well plate is heated up to expand, the second driving mechanism then drives the supporting block to move down, tubes of the PCR well plate smoothly enter the well grooves of the PCR base, and then, the first driving mechanism drives the hot cover to cover on the upper surface of the PCR well plate for performing the PCR. After the PCR is ended, the first driving mechanism drives the hot cover to move up, and the second driving mechanism then drives the supporting block to move up to push against the PCR well plate so as to facilitate taking out the PCR well plate and also prevent the tubes from being clamped in the well grooves of the PCR base after the PCR well plate is cooled to contract.

### BRIEF DESCRIPTION OF DRAWINGS

In order to describe technical solutions in embodiments of the present invention more clearly, drawings to be used in the embodiments or descriptions of the prior art will be briefly introduced below. Obviously, the drawings in the following descriptions are merely some embodiments of the present invention, and those of ordinary skill in the art can also obtain other drawings according to these drawings without paying creative work.

FIG. 1 is a structural schematic diagram illustrating thermal deformation of a PCR well plate in the prior art.

FIG. 2 is a structural schematic diagram of an embodiment according to the present invention.

FIG. 3 is a structural schematic diagram of another embodiment according to the present invention.

FIG. 4 is a structural schematic diagram of yet another embodiment according to the present invention.

FIG. 5 is a structural schematic diagram of yet another embodiment according to the present invention.

FIG. 6 is a structural schematic diagram of yet another embodiment according to the present invention.

FIG. 7 is a structural schematic diagram of yet another embodiment according to the present invention.

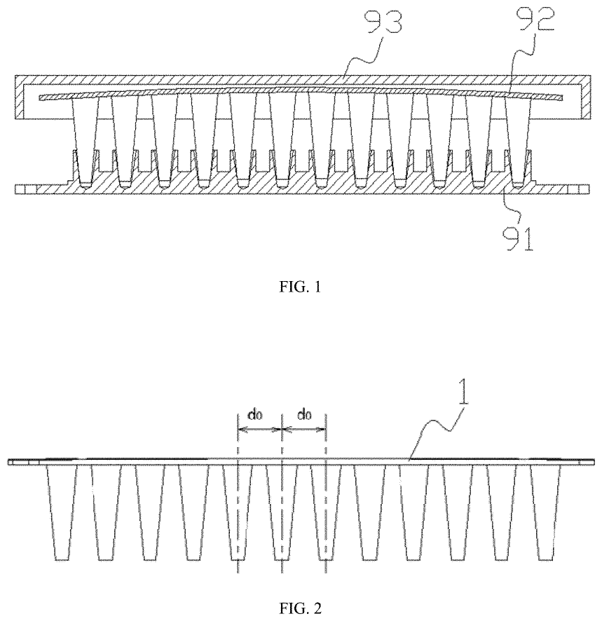

Names of corresponding components indicated by numerals and letters in the drawings are described as follows:

1—PCR well plate; 2—PCR base; 3—upper heating unit; 31—hot cover; 32—heating element; 4—lower temperature controlling unit; 41—cooling sheet; 42—water cooling plate; 5—supporting block; 51—vertical guide post; 6—second driving mechanism; 61—beveled block; 62—lead screw pair; 63—drive motor; 91—PCR base; 92—PCR well plate; 93—hot cover.

### DESCRIPTION OF EMBODIMENTS

Technical solutions of embodiments of the present invention will be described clearly and fully below in combination with drawings in the embodiments of the present invention. Obviously, the described embodiments are merely part of embodiments of the present invention rather than all embodiments. Other embodiments obtained by those of ordinary skill in the art based on the embodiments in the present invention without paying creative work shall all fall into the protection scope of the present invention.

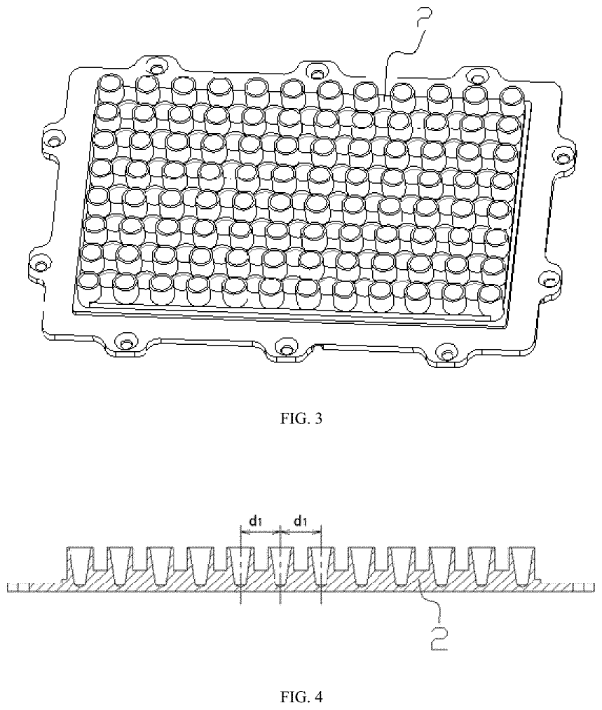

As shown in FIGS. 2-4, an embodiment of the present invention provides a PCR base 2 including a metal block. The metal block is provided with a plurality of well grooves for holding tubes on a PCR well plate; under an ambient condition of a room temperature being 22±2° C., a well spacing of the PCR well plate 1 is d₀, a well spacing of the PCR base 2 is d₁, the well spacing d₁ of the PCR base 2 is greater than the well spacing d₀ of the PCR well plate 1, and d₁=d₀+Δd, where Δd refers to a thermal expansion compensation value.

The above technical solution has the following beneficial effects: during the PCR, the well spacing d₀ of the heated PCR well plate extends to be close to the well spacing d₁ of the PCR base, the well grooves of the PCR base no longer limit expansion and extension of the PCR well plate, a surface of the PCR well plate is in a planar state, and an upper hot cover can be well covered on the surface of the PCR well plate. Therefore, evaporation and cross-contamination of test solution in the PCR well plate are prevented, heating uniformity of each well position of the PCR well plate is improved, and accuracy of PCR detection is increased.

In other embodiments of the present invention, the thermal expansion compensation value is Δd=ΔT*s*d₀, where ΔT refers to a temperature difference value being 20-80 K, and s refers to a thermal expansion coefficient of a material of the PCR well plate and is (30−250)*10⁻⁶ mm/K.

In other embodiments of the present invention, the well spacing d₁ of the PCR base 2 is (1+0.06%)d₀≤d₁≤(1+2%)d₀. The thermal expansion compensation value with wide applicability is obtained according to a common material expansion rate of the PCR well plate and a large number of pilot experiments, thereby effectively eliminating arching deformation of the heated PCR well plate and considering universality of the PCR base at the same time.

A 96-well PCR well plate is taken as an example. When the PCR well plate is made of PP, its thermal expansion coefficient s is 90*10⁻⁶ mm/K, and the temperature difference value ΔT is 80 K. Under the ambient condition of the room temperature being 22±2° C., the well spacing of the PCR well plate is d₀=9 mm, and the well spacing of the PCR base is d₁=(1+80*90*10⁻⁶)*9=9.0648 mm. According to the common material and the heating temperature, the well spacing d₁ of the PCR base applicable to the 96-well plate is 9.03-9.22 mm.

A 384-well PCR well plate is taken as an example. When the PCR well plate is made of glass fiber ABS, its thermal expansion coefficient is 30*10⁻⁶ mm/K, and the temperature difference value ΔT is 20 K. Under the ambient condition of the room temperature being 22±2° C., the well spacing of the PCR well plate is d₀=4.5 mm, and the well spacing of the PCR base is d₁=(1+30*20*10⁻⁶)*4.5=4.5027 mm. According to the common material and the heating temperature, the well spacing d₁ of the PCR base applicable to the 384-well plate is 4.5027-4.55 mm.

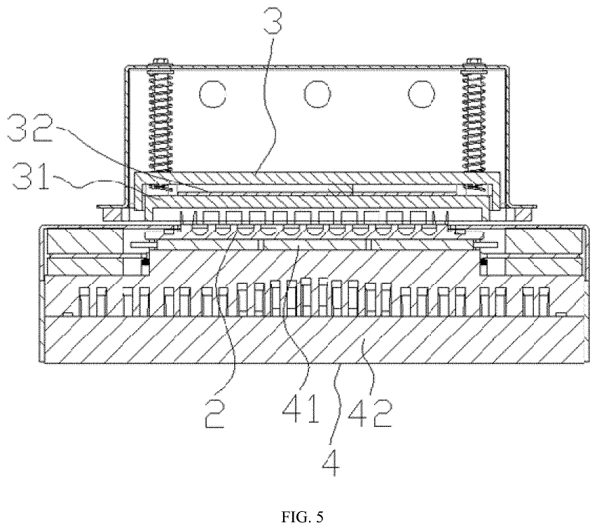

As shown in FIG. 5, a PCR instrument includes:

a PCR base 2, on which a PCR well plate (not shown in FIG. 5) is placed, wherein a well spacing of the PCR base 2 is greater than a well spacing of the PCR well plate;

an upper heating unit 3, including a hot cover 31 and a heating element 32, wherein the heating element 32 is used to heat the hot cover 31, and the hot cover 31 is covered on an upper surface of the PCR well plate during a PCR; and

a lower temperature controlling unit 4, disposed below the PCR base 2 and used to perform temperature control for the PCR base 2.

The above technical solution has the following beneficial effects: the heated PCR well plate no longer deforms, and the hot cover can be matched with the surface of the PCR well plate better.

The lower temperature controlling unit 4 may perform temperature control by wind cooling or water cooling. As shown in FIG. 5, the lower temperature controlling unit 4 includes a cooling sheet 41 and a water cooling plate 42, an upper surface of the cooling sheet 41 is attached to a bottom surface of the PCR base 2, a lower surface of the cooling sheet 41 is attached to an upper surface of the water cooling plate 42, and a circulation coolant flows in the water cooling plate 42. The above technical solution has the following beneficial effects: a temperature control speed can be increased by water cooling to improve a PCR experimental efficiency.

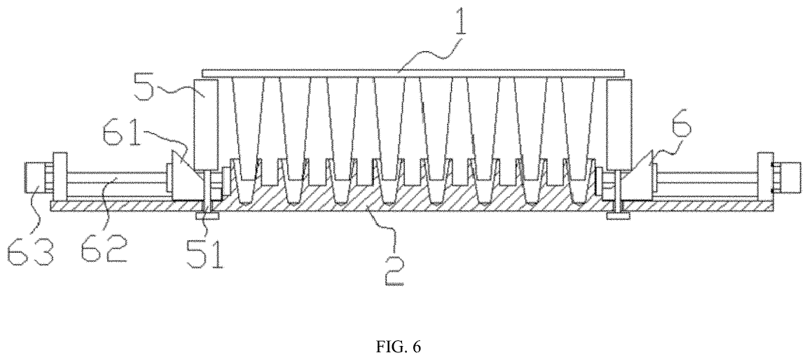

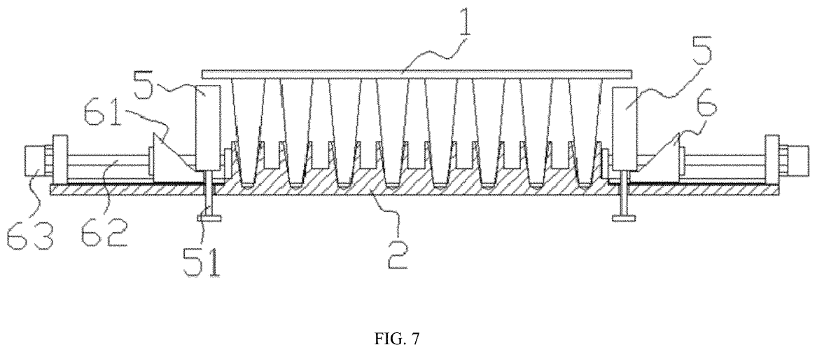

As shown in FIGS. 6-7, since the well spacing of the PCR base is greater than the well spacing of the PCR well plate in the PCR instrument at a normal temperature, if the PCR well plate is directly placed in the PCR base at the normal temperature, tube walls of the PCR well plate collide with well grooves of the PCR base, causing concave deformation of the PCR well plate. After the hot cover is pressed against the PCR well plate, the PCR well plate is difficult to smoothly extend along a plane after subsequent heating, so that the following solution of the embodiment mainly solves the technical problem. In other embodiments of the present invention, the PCR instrument further includes a first driving mechanism (not shown) for driving the upper heating unit to ascend and descend. A supporting block 5 is disposed on the PCR base 2 corresponding to an edge below a lip side of the PCR well plate 1, a vertical guide post 51 is disposed at the bottom of the supporting block 5, a guide hole matched with the vertical guide post 51 is disposed on the PCR base 2, and a second driving mechanism 6 for driving the supporting block 5 to move up and down is further included. The second driving mechanism 6 includes a beveled block 61, a horizontally disposed lead screw pair 62 and a drive motor 63, the supporting block 5 is mounted on a bevel of the beveled block 61, the beveled block 61 is connected with a nut of the lead screw pair 62, and the drive motor 63 drives a lead screw of the lead screw pair 62 to rotate. The above technical solution has the following beneficial effects: before the PCR well plate 1 is placed, the second driving mechanism 6 drives the beveled block 61 to shift inward to enable a bevel of the beveled block 61 to push against the supporting block 5, the PCR well plate 1 placed thereon is supported on the supporting block 5 by means of its lip side at the edge, and the tubes of the PCR well plate 1 are not in full contact with the well grooves of the PCR base 2 (a state shown in FIG. 6), thereby effectively preventing concave deformation of the PCR well plate mounted on the PCR base before thermal expansion. After the PCR well plate 1 is heated to expand, the well spacing of the PCR well plate is close to the well spacing of the PCR base, the second driving mechanism 6 drives the beveled block 61 to shift outward, the supporting block 5 moves down, the tubes of the PCR well plate 1 smoothly enter the well grooves of the PCR base 2 (a state shown in FIG. 7), and then, the first driving mechanism drives the hot cover to cover on the upper surface of the PCR well plate 1 for performing the PCR. After the PCR is ended, the first driving mechanism drives the hot cover to move up, and the second driving mechanism 6 then drives the supporting block 5 to move up to push against the PCR well plate 1 so as to facilitate taking out the PCR well plate 1 and also prevent the tubes from being clamped in the well grooves of the PCR base 2 after the PCR well plate 1 is cooled to contract.

The above embodiments are merely used to describe technical conceptions and features of the present invention so as to enable those of ordinary skill in the art to understand and implement contents of the present invention, but cannot be used to limit the protection scope of the present invention. Equivalent changes or modifications made based on the spirit of the present invention shall all fall in the protection scope of the present invention.

1. A PCR base for placing a PCR well plate, comprising a metal block, wherein the metal block is provided with a plurality of well grooves for holding tubes on the PCR well plate; under an ambient condition of a room temperature being 22±2° C., a well spacing of the PCR well plate is d₀, a well spacing of the PCR base is d₁, the well spacing d₁ of the PCR base is greater than the well spacing d₀ of the PCR well plate, and d₁=d₀+Δd, wherein Δd refers to a thermal expansion compensation value;
wherein the thermal expansion compensation value is Δd=ΔT*s*d0, wherein ΔT refers to a temperature difference value being 20-80 K, and s refers to a thermal expansion coefficient of a material of the PCR well plate and is (30−250)*10-6 mm/K.

2. (canceled)

3. The PCR base according to claim 1, wherein the well spacing d₁ of the PCR base is (1+0.06%)d₀≤d₁≤(1+2%)d₀.

4. A PCR instrument, comprising:
the PCR base according to claim 1, on which a PCR well plate is placed;
an upper heating unit, comprising a hot cover and a heating element, wherein the heating element is used to heat the hot cover, and the hot cover is covered on an upper surface of the PCR well plate during a polymerase chain reaction (PCR); and
a lower temperature controlling unit, disposed below the PCR base and used to perform temperature control for the PCR base.

5. The PCR instrument according to claim 4, further comprising a first driving mechanism for driving the upper heating unit to ascend and descend.

6. The PCR instrument according to claim 5, wherein a supporting block is disposed on the PCR base corresponding to an edge below a lip side of the PCR well plate, a vertical guide post is disposed at the bottom of the supporting block, a guide hole matched with the vertical guide post is disposed on the PCR base, and a second driving mechanism for driving the supporting block to move up and down is further comprised.

7. The PCR instrument according to claim 6, wherein the second driving mechanism comprises a beveled block, a horizontally disposed lead screw pair and a drive motor, the supporting block is mounted on a bevel of the beveled block, the beveled block is connected with a nut of the lead screw pair, and the drive motor drives a lead screw of the lead screw pair to rotate.

8. A PCR instrument, comprising:
the PCR base according to claim 3, on which a PCR well plate is placed;
an upper heating unit, comprising a hot cover and a heating element, wherein the heating element is used to heat the hot cover, and the hot cover is covered on an upper surface of the PCR well plate during a polymerase chain reaction (PCR); and
a lower temperature controlling unit, disposed below the PCR base and used to perform temperature control for the PCR base.

9. The PCR instrument according to claim 8, further comprising a first driving mechanism for driving the upper heating unit to ascend and descend.

10. The PCR instrument according to claim 9, wherein a supporting block is disposed on the PCR base corresponding to an edge below a lip side of the PCR well plate, a vertical guide post is disposed at the bottom of the supporting block, a guide hole matched with the vertical guide post is disposed on the PCR base, and a second driving mechanism for driving the supporting block to move up and down is further comprised.

11. The PCR instrument according to claim 10, wherein the second driving mechanism comprises a beveled block, a horizontally disposed lead screw pair and a drive motor, the supporting block is mounted on a bevel of the beveled block, the beveled block is connected with a nut of the lead screw pair, and the drive motor drives a lead screw of the lead screw pair to rotate.
